(19) United States
(12) Patent Application Publication
(10) Pub. No.: US 2006/0108389 A1
(43) Pub. Date: May 25, 2006

(54) Pinion nail verification assembly

(76) Inventor: Alan Phillips, Jackson, TN (US)

Correspondence Address: THE BLACK & DECKER CORPORATION, 701 EAST JOPPA ROAD, TW199, TOWSON, MD, 21286, US

(21) Appl. No.: 10/664,830

(22) Filed: Sep. 17, 2003

Related U.S. Application Data
(60) Provisional application No. 60/411,563, filed on Sep. 18, 2002.
(60) Provisional application No. 60/471,641, filed on May 19, 2003.

(51) Int. Cl. B25C 5/06

(52) U.S. Cl. 227/120

(57) ABSTRACT

A pinion nail verification assembly enables a nail gun to reduce the number of times incorrectly positioned nails are operated upon by the nail gun. A pinion is coupled with an axle disposed in a nail loading assembly which stores and provides the nails to a nail driving assembly. The pinion engages with the nails in the nail loading assembly and allows those nails which are properly aligned to advance down the nail loading assembly to the nail driving assembly and reduce the number of times the incorrectly positioned nail are operated upon by hindering the advancement of such incorrectly positioned nails.

### CROSS REFERENCE TO RELATED APPLICATION

The present application claims priority under 35 U.S.C. §119(e) to the U.S. Provisional Application Ser. No. 60/411,563, filed on Sep. 18, 2002, and the U.S. Provisional Application Ser. No. 60/471,641, filed on May 19, 2003. The U.S. Provisional Application 60/411,563 and 60/471,641 are herein incorporated by reference in their entireties.

### FIELD OF THE INVENTION

The present invention generally relates to the field of power tools, and particularly to a pinion nail verification assembly for use in a nail gun, such as a pneumatic nail gun.

### BACKGROUND OF THE INVENTION

The use of pneumatic tools is commonplace in many workplace environments. Tools such as a pneumatic nail gun (nail gun) require the use of instruments (i.e., nails) that meet specific conditions in order to ensure proper operation of the nail gun. Use of incorrect nails may result in damage to the tool and lost time and money. Unfortunately, the tool itself often does not provide any effective way to verify that the nail being employed is correct and/or if the nail is not correct to reduce the chances of the incorrect nail from advancing within the tool.

Many of the pneumatic tool devices which employ instruments, such as nails, rely on the operator to determine the correct instrument to employ. For instance, one nail gun may require the use of clipped head nails provided in a collated strip at a specific angle. The operator of the nail gun is then required to provide these types of nails, the only verification is provided by the operator's skill, knowledge, and experience with the nail gun. However, it may be the case that one operator is less experienced than another or that the nail gun is provided to the operator already loaded with nails. There have been no effective ways provided by the current state of the art to enable the tool to verify that the correct nails are being employed, regardless of the skill, knowledge, and experience of the operator.

Therefore, it would be desirable to provide a pneumatic tool enabled to verify the correct use of instruments within it and reduce the chances of an improper instrument advancing and being operated upon, which may result in serious harm to the tool.

### SUMMARY OF THE INVENTION

Accordingly, the present invention is directed to a pinion nail verification assembly disposed within a pneumatic tool, such as a nail gun, which provides an operator of the pneumatic tool an effective way to ensure that only the correct nails are loaded and advanced within the tool. The tool itself becomes a regulating device, in effect identifying for the operator whether or not the nails the operator has chosen are correct for the particular tool. By using the present invention, damage to the tool may be significantly diminished, even if the operator is relatively inexperienced simply because the nails may not be allowed to advance in the tool if they are incorrect. In a first aspect of the present invention, a pinion nail verification assembly includes an axle coupled with a nail loading assembly, the axle for providing an axis of rotation. A pinion is coupled with the axle and engages nails advancing down the nail loading assembly. The pinion assembly engages the nail within the housing and allows the nail to advance to the nail driving assembly when the nail is correctly positioned parallel with the axis of rotation of the axle.

In a second aspect of the present invention, an adjustable angle magazine is provided which adjustably couples to a nail driving assembly of a nail gun. The adjustable angle magazine comprises a housing including a first end and a second end, the housing stores a nail and provides nails in a collated nail strip to the nail driving assembly. An adjustment assembly is disposed proximal to the second end of the housing, the adjustment assembly for affixing the position of the housing relative to the nail gun. A universal adapter assembly is coupled to a first end of the adjustable angle magazine and enables the pivoting coupling of the adjustable angle magazine with the nail driving assembly. A pinion nail verification assembly is coupled with the housing and engages with the nails advancing down the housing. The pinion nail verification assembly engages the nail within the housing and allows the nail to advance to the nail driving assembly when the nail is correctly positioned.

In a third aspect of the present invention, an adjustable angle nail gun is provided. The adjustable angle nail gun comprises a handle with a first end and a second end coupled with a fastening assembly. A nail driving assembly including a driver blade is coupled with the first end of the handle and is for driving nails in a collated nail strip. An adjustable angle nose casting assembly is coupled with the nail driving assembly. The adjustable angle nose casting assembly enables the operational engagement of the driver blade with the nail. An adjustable angle magazine for storing and providing the nails is pivotally coupled with the adjustable angle nose casting assembly. A universal adapter assembly is coupled with a first end of the adjustable angle magazine and enables the pivotal coupling of the adjustable angle magazine with the adjustable angle nose casting assembly. An adjustment assembly disposed proximal to the second end of the adjustable angle magazine couples with the fastening assembly. A pinion nail verification assembly is coupled with the housing and engages with the nails advancing down the housing. The pinion nail verification assembly engages the nail within the housing and allows the nail to advance to the nail driving assembly when the nail is correctly positioned.

In a fourth aspect of the present invention, a method for determining whether a proper collated nail strip has been loaded into a nail loading assembly for driving by a nail driving assembly of a nail gun. An operator of a nail gun selects and loads the collated nail strip into the nail loading assembly. As the nail strip advances through the nail loading assembly the nails are engaged by a pinion nail verification assembly. The pinion nail verification assembly determines whether the collated nail strip provides nails in the correct position for use by the nail gun. If the nails are correctly positioned then they are allowed to advance and be received into the nail driving assembly. If the nails are incorrectly positioned then they are not allowed to advance and are locked in place within the nail loading assembly.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an illustration of an adjustable angle nail gun assembly.

FIG. 2 is a cut-away view of a pinion nail verification assembly in accordance with an exemplary embodiment of the present invention.

FIG. 3A is cross-sectional view of the pinion nail verification assembly;

FIG. 3B is an overhead view of the pinion nail verification assembly adjusted to accept round-headed nails; and

FIG. 4 is a flowchart illustrating a method for using a nail gun by determining whether a collated nail strip is correct for the nail gun.

### DETAILED DESCRIPTION OF THE INVENTION

Reference may now be made in detail to the presently preferred embodiments of the invention, examples of which are illustrated in the accompanying drawings.

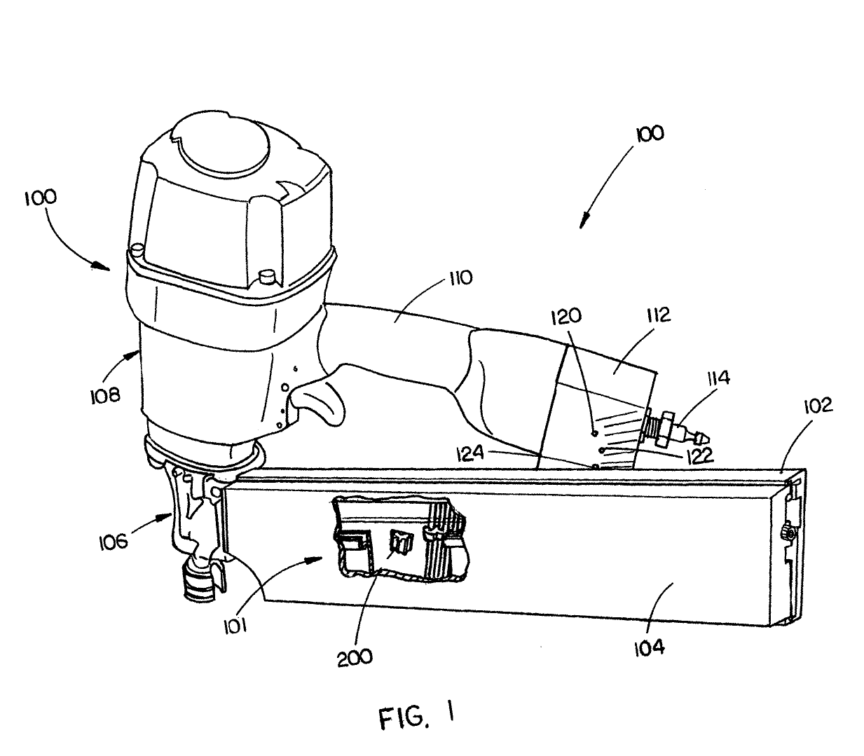

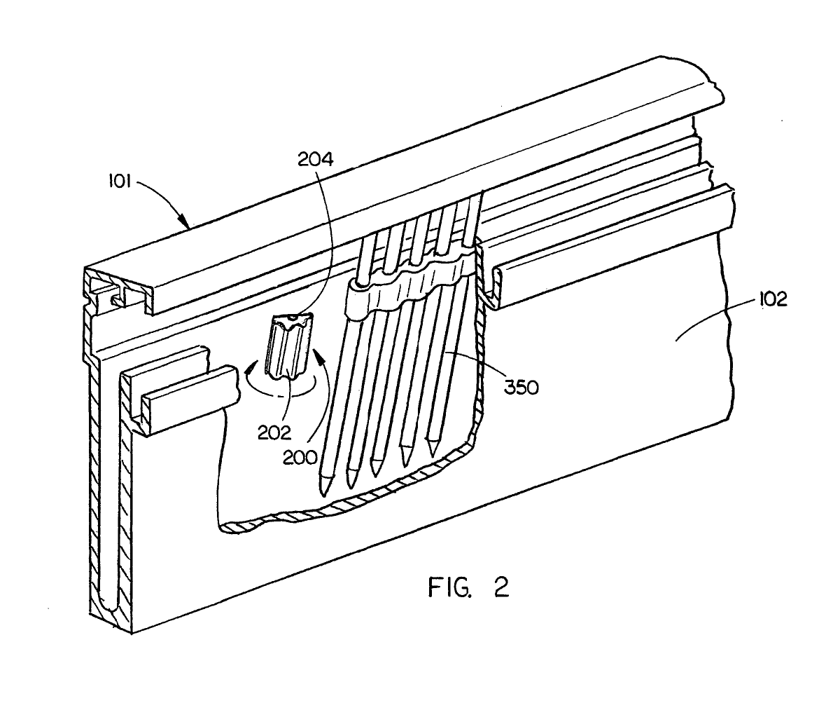

Referring generally now to FIGS. 1 through 4, exemplary embodiments of the present invention are shown.

In FIG. 1 an adjustable angle nail gun assembly 100 including a nail loading assembly, such as an adjustable angle magazine 101, is shown. The adjustable angle magazine 101 includes a housing 102 and a cover 104 and is shown enabled to couple with an adjustable angle nose casting assembly 106. The adjustable angle nose casting assembly 106 couples with a nail driving assembly disposed within the nail gun casing 108. A handle 110 couples with the nail gun casing 108 at one end and with a fastening assembly 112 at the opposite end. The fastening assembly 112 couples with a compressor connection assembly 114 and with the housing 102 of the adjustable angle magazine 101. The cover 104 is removable from the housing 102, preferably, sliding off to the end opposite the connection with the nose casting assembly 106. A pinion nail verification assembly 200 is disposed within the adjustable angle magazine 101.

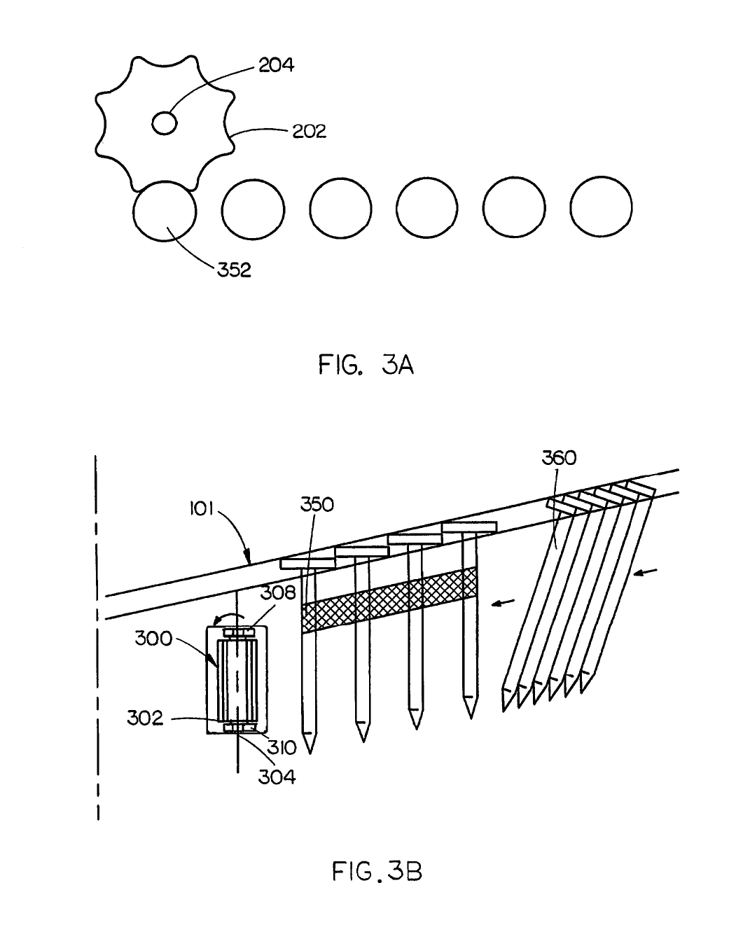

The pinion nail verification assembly 200, shown in FIGS. 1, 2, 3A, and 3B comprises a pinion 202 and a central axle 204. The pinion 202 is shown engaged with a first nail 352 in FIG. 3A. The pinion 202 engages the nail shank below the head of the nail 352. The pinion 202 is grooved to accept the nail shank when the nail shank is properly presented. Proper presentation of the nail shank relates to the angle of the nail in a collation magazine. Thus, the pinion 202 may be used to verify that the nails inserted in a adjustable angle magazine 101 are parallel to the driver blade. The pinion 202 is positioned above the nails with minimal clearance, in FIG. 3A, and the axis or axle 204 is set parallel to the driver blade of a nail gun assembly, such as the adjustable angle nail gun assembly 100 of the present invention. If the axis of the nail shanks advancing down the adjustable angle magazine 101 is parallel to the axis or axle 204 coupled with the pinion 202, then the advancing nail strip, as exemplified by a collated round-head nail strip 350 or a collated clipped-head nail strip 360, may cause the pinion to rotate and allow the nail strip to pass. If incorrectly positioned nails are inserted into the adjustable angle magazine 101, the nail shank axis may not be parallel to the axis or axle 204 coupled with the pinion 202. This may cause the pinion 202 to incorrectly engage with the nail shank and impeded the pinion 202 from rotating, thus the incorrectly positioned nail strip has its ability to advance down the adjustable angle magazine 101 severely hindered. It is understood that through the combination of the pinion 202 profile and the axis or axle 204 setting, nail strips presenting with an incorrect angle may be excluded from passing under the driver blade. This may be advantageous in reducing possible damage to the nail gun.

The adjustable angle magazine 101 provides the operator of a nail gun the ability to use a variety of nail types collated at a variety of angles within the same nail gun. Typically, the adjustable angle magazine may comprise a housing configured generally to appear as a standard nail gun magazine with a cover slidably coupled with it. The housing may be configured for operation without the cover. In alternative embodiments, the housing may be coil-type casing where the connected nails are arranged in a long belt, which winds around a spool. The coil-type casing may be configured in a variety of ways, such as a horizontal coil-type casing or a vertical coil-type casing. The cover may be configured to operate with alternative embodiments, such as the coil-type casing, or may not be included. It is understood that alternative design embodiments of the housing and cover may be employed and do not depart from the scope and spirit of the present invention.

It is contemplated that a universal adapter assembly is coupled with the adjustable angle magazine. The universal adapter assembly may include a seating member and a rail member. The rail member may couple with the housing through the use of a fastening device, such as a clip, screw, pin, and the like. The number and location through the rail member and housing where the fasteners are employed may vary as contemplated by one of ordinary skill in the art. In the preferred embodiment, the universal adapter assembly may be coupled with the housing at the end of the housing that engages with a nail gun. A first bolt engaged by a first nut and a second bolt engaged by a second nut may secure the universal adapter assembly to the housing. The first bolt may engage through a first fastening point disposed on the universal adapter assembly. A first housing fastening point may align with the first fastening point and allow the first bolt to pass through and be engaged by the first nut. The second bolt may pass through a second fastening point and a second fastening point to engage with the second nut. It is understood that the fastening points located on both the universal adapter assembly and the housing may be located in various positions. Further, the method of fastening the universal adapter assembly to the housing may be varied. For example, the universal adapter assembly may be locked in place through a compression lock assembly with a release button assembly to allow for removal from the housing.

The seating member may be designed for engaging a cradle of the adjustable angle nose casting assembly. The seating member may comprise a first arm coupled with a second arm. The seating member may further comprise a notch that is coupled with the first and second arm. A transition plate may be coupled to the second arm of the seating member. The first and second arm may be configured with rounded heads for engagement with the cradle. This rounded head configuration enables rotational movement of the seating member once engaged with the cradle. The notch may be disposed across both the first and second arm and may be engaged by a fastening assembly to secure its position. Preferably, the notch may comprise a smooth surface to allow a cradle fastening assembly to slide upon it thereby enabling the rotational movement of the seating member.

The transition plate may provide a connection to the adjustable angle magazine. The transition plate may engage with the adjustable angle magazine to securely affix the seating member. The transition plate may couple with the housing through the use of a bolt and a nut. The bolt may engage the transition plate by first engaging a housing fastening point and next a transition plate fastening point. In the present embodiment, the housing fastening point and transition plate fastening point are apertures. The bolt may then engage the nut to fasten the housing to the transition plate. It is also contemplated that a variety of fasteners may be used to couple the transition plate with the housing, such as clips, screws, pins, and the like. The rail member may provide further connection to the adjustable angle magazine. The rail member may also couple along a side of the adjustable angle magazine.

The fastening assembly 112 includes a plurality of angular adjustment sites, as exemplified by a first angular adjustment site 120, a second angular adjustment site 122 and a third angular adjustment site 124. The fastening assembly 112 is disposed with a plurality of angle identifiers. The angle identifiers are a series of indicators associated with a printed number (i.e., 30, 29, 28, 27 . . . ) which corresponds to the angle of presentation of the adjustable angle magazine 101 to the adjustable angle nose casting assembly 106. It is contemplated that the angle identifiers may be a label with the numbers printed upon them which may be adhered to the fastening assembly 112. Alternatively, the numbers may be engraved or painted upon the fastening assembly 112.

In the current embodiment, it is understood that the plurality of angular adjustment sites may be engaged by a fastener, such as a bolt, screw, pin, and the like. The fastener may engage through the housing 102 via an adjustment assembly comprising a first angular connection site and a second angular connection site. Alternatively, the number of angular connection sites may vary as contemplated by one of ordinary skill. The fastener engages through the first or second angular connection site and connects with one of the plurality of angular adjustment sites.

In an alternative embodiment, the fastening assembly employed by the present invention may be variously configured. For example, the fastening assembly may be implemented using a worm drive assembly. In such a configuration, a threaded shaft may be disposed within the fastening assembly and operationally coupled with a threaded sleeve. The threaded sleeve may be enabled to move up and down the threaded shaft through rotation of a mechanical rotation assembly, which couples with the threaded shaft, by an operator of the nail gun. A post coupled with the housing of the adjustable angle magazine may be further coupled to the threaded sleeve, thus enabling the angular adjustment of the adjustable angle magazine. Other configurations may include a pneumatic fastening system, hydraulic fastening system, alternative mechanical systems, and the like. For instance, the fastening assembly may utilize the compressed air provided through the compressor connection assembly by redirecting the flow of a portion of the compressed air into a gauge assembly. The gauge assembly may include a readout which provides a visual indication to the operator of the angle of the nail loading assembly relative to the adjustable angle nose casting assembly of the adjustable angle nail gun. Further, the gauge assembly may include an actuator which may allow the operator of the adjustable angle nail gun to alter the flow of the compressed air into the gauge assembly either increasing or decreasing the flow. Alternatively, the gauge assembly may provide a bleed-off valve assembly enabling the operator to regulate the release of the compressed air in the gauge assembly. Either by increasing and decreasing the air flow or bleeding-off the compressed air the operator may change the angle of the adjustable angle magazine relative to the adjustable angle nose casting assembly. The gauge assembly may control the angle of the adjustable angle magazine via a piston assembly engaging with the housing of the adjustable angle magazine. The piston assembly may include a piston engaging a shaft which is coupled with the housing, thus, as the shaft moves so to does the housing of the adjustable angle magazine. It is understood the piston moves the shaft by reacting to changing air pressures within.

In an alternative embodiment, a mechanical fastening system may include a ratchet assembly with a hand brake. The hand brake is engaged by the operator and through pressure applied to the hand brake the ratchet assembly raises or lowers the housing of the adjustable angle magazine. For example, the hand brake may include a spring loaded snap joint which provides incremental adjustments of the angle of the housing relative to the adjustable angle nose casting assembly. The spring loaded snap joint engages a multi-position actuator which engages the ratcheting assembly. The hand brake may be disposed on the handle of the nail gun assembly to provide easy access and control over the nail gun assembly during operation of the hand brake.

It is also contemplated that a support assembly comprising a first support member disposed on the housing and a second support member disposed on the cover may provide additional support for the adjustable angle magazine 101. The first and second support member may be configured to engage with a first support bar and a second support bar that protrude from the adjustable angle nose casting assembly. The engagement of the support bars and members may provide stability to the adjustable angle nail gun during operation. In the preferred embodiment, the first and second support members may comprise a section of the cover and housing, respectively, and include serrated or toothed sections. These serrated or toothed sections of the first and second support member may be designed to engage with complimentary serrated or toothed sections disposed upon the first and second support bar. Additionally, this combination may be designed to be releasably engaged, allowing for the easy adjustment of the angle of the housing relative to the adjustable angle nose casting assembly.

In the alternative the first and second support members may be coupled to the first and second support bars and include a mechanism for concomitant adjustment when the adjustment assembly is re-adjusted. For example, a worm drive assembly may be employed that allows for movement to adjust and then locks in place when the desired position has been reached. Alternatively, a compression lock assembly may be employed to accomplish the same re-positioning enabled by the adjustment assembly in combination with the nail gun fastening assembly discussed previously.

In an alternative embodiment, the adjustable angle nail gun assembly may be a pneumatic nail gun. Further, the adjustable angle nail gun may be a spring-loaded nail gun assembly. The spring-loaded nail gun assembly utilizing electricity to drive a motor which may engage a spring that drives the driver blade. In another embodiment, the adjustable angle nail gun may be an electromagnetic nail gun assembly utilizing a solenoid to provide the driving force to the driver blade. The solenoid may include an electromagnetic coil with a sliding piston inside it. Other embodiments of the solenoid may include a spring assembly to draw the piston back in. In a still further embodiment, the adjustable angle nail gun may be a combustion nail gun assembly utilizing a piston driven by the firing of gas in a combustion chamber to drive the driver blade. It is contemplated that the adjustable angle nail gun may be configured as a motor driven nail gun. Thus, the adjustable angle nail gun may be configured with electric motors and the like. Further, the motors may include clutch assemblies for providing the needed force to operate the driver blade and drive a nail. The configuration of the motor and clutch assemblies employed may vary as contemplated by one of ordinary skill in the art without departing from the scope and spirit of the present invention.

It is also contemplated that in other embodiments of the present invention a compression cover may be coupled with the housing. The compression cover may engage with the housing through a compression lock system comprising a plurality of compression clips disposed on the compression cover and through points disposed on the housing. Other systems and methods of coupling the cover to the housing may be employed as contemplated by one of ordinary skill in the art.

Further, the adjustable angle magazine of the present invention may be disposed with various other devices and mechanisms. These may include a pick-off pivot assembly, an articulating pusher assembly, a nail shank pawl assembly, and the like. Additionally, the adjustable angle magazine may be enabled as a top-loading magazine, a side-loading magazine, and the like as may be contemplated by one of ordinary skill in the art.

Referring now to FIG. 3B, a pinion nail verification assembly 300 is shown disposed in the adjustable angle magazine 101. In this preferred embodiment, the pinion 302 in engaged by a first mounting member 308 and a second mounting member 310. The first and second mounting members 308 and 310 allow the pinion 302 to rotate about an axis 204. The first and second mounting members 308 and 310 are further enabled to adjust the axis 204 of rotation according to the angle of the adjustable angle magazine 101. In this manner the axis of the pinion 302 is always maintained parallel to the driver blade, which is operationally engaged through the adjustable angle nose casting assembly 106. It is contemplated that the pinion nail verification assembly 200 and 300 may be a modular assembly. In such an instance, the pinion nail verification assembly 200 and 300 may couple with a nail loading assembly outfitted to accept the modular pinion nail verification assembly 200 and 300. The modular system may fasten to the nail loading assembly using a variety of devices, such as compression locks, snaps, bolts, screws, and the like. It is further contemplated that the modular system may be interchangeable with a variety of nail loading assemblies. This would be advantageous in that a single modular pinion nail verification assembly may enable a plurality of nail loading assemblies with the nail verification system it affords. It is still further contemplated that in another embodiment of the present invention a first and second mounting member may be coupled with a projection on the adjustable angle nose casting assembly 106. The projection would be suitable for maintaining the pinion 302 in its parallel alignment with the driver blade as the adjustable angle magazine 101 is rotated to the proper setting.

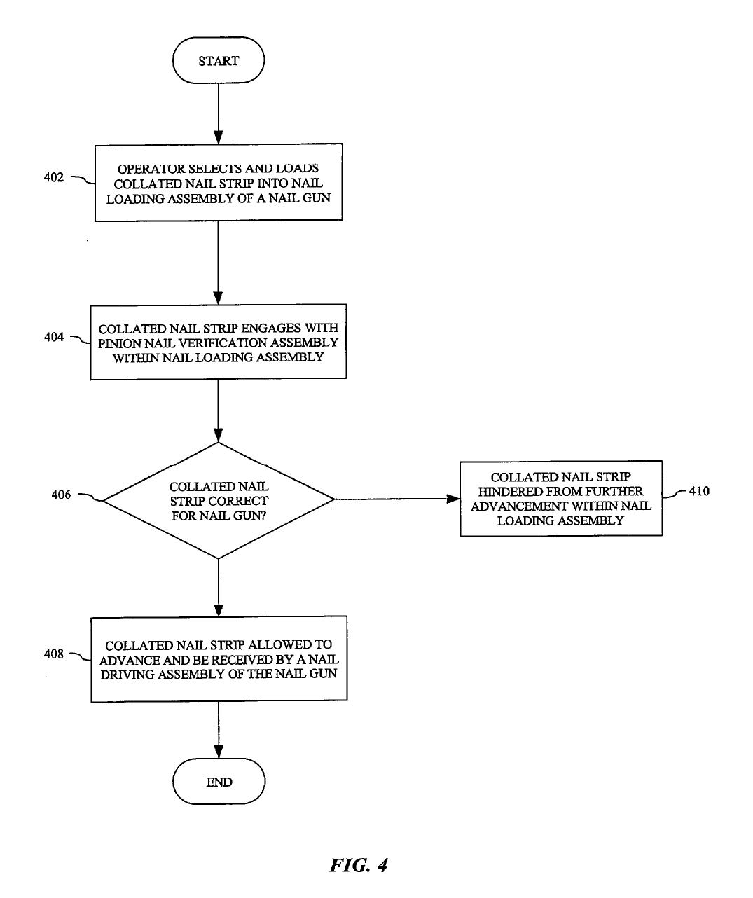

A method for determining whether a proper collated nail strip is being advanced to a nail driving assembly from a nail loading assembly of a nail gun, is shown in FIG. 4. In a first step 402, the operator of the nail gun initially loads a collated nail strip into the nail loading assembly. It is understood that the collated nail strip may be loaded into a nail loading assembly with various loading configurations, such as rear-loading, top-loading, side-loading, and the like. The nails of the collated nail strip, in step 404, engage with a pinion nail verification assembly disposed within the nail loading assembly. In step 406 the pinion nail verification assembly determines if the collated nail strip, which is being advanced through the nail loading assembly to the nail driving assembly for operation upon by the nail driving assembly, is providing the nails in the correct position for the nail gun. If it is determined that the nails being provided are in the correct position for operation upon by the nail driving assembly, then in step 408 the pinion nail verification assembly allows the collated nail strip to advance. The advancing collated nail strip has the nails received by the nail driving assembly where the nails may be driven. If, however, it is determined that the nails being provided are incorrectly positioned for operation upon by the nail driving assembly, then in step 410 the pinion nail verification assembly may severely hinder the advancement of the collated nail strip by engaging with the nails and locking in position, thereby locking the nail strip in place within the nail gun. When the pinion nail verification assembly locks in position the operator of the nail gun is provided an indication that the collated nail strip the operator selected is incorrect for use with the nail gun.

It is understood that the specific order or hierarchy of steps in the methods disclosed are examples of exemplary approaches. Based upon design preferences, it is understood that the specific order or hierarchy of steps in the method can be rearranged while remaining within the scope and spirit of the present invention. The accompanying method claims present elements of the various steps in a sample order, and are not necessarily meant to be limited to the specific order or hierarchy presented.

It is believed that the present invention and many of its attendant advantages may be understood by the forgoing description. It is also believed that it may be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

1. A pinion nail verification assembly for use in a nail loading assembly coupled with a nail driving assembly of a nail gun, comprising:
an axle coupled with the nail loading assembly, the axle for providing an axis of rotation, the nail loading assembly being an adjustable angle magazine;
a universal adapter assembly coupled to the adjustable angle magazine for allowing the pivotal coupling of the adjustable angle magazine with the nail driving assembly; and
a pinion coupled with the axle, the pinion for engaging a nail advancing down the nail loading assembly,
wherein the pinion assembly allows the nail to advance to the nail driving assembly when the nail is correctly positioned parallel with the axis of rotation of the axle.

2. The pinion nail verification assembly of claim 1, further comprising a lock assembly coupled with the pinion, the lock assembly for locking the position of the pinion.

3-7. (canceled)

8. The pinion nail verification assembly of claim 1, wherein the nail gun is selected from the group consisting of a spring-loaded nail gun, a pneumatic nail gun, an electromagnetic nail gun, a combustion nail gun, and a motor driven nail gun.

9. The pinion nail verification assembly of claim 1, wherein the nail gun further comprises a clutch assembly.

10-40. (canceled)

41. A pinion nail verification assembly for use in a nail loading assembly coupled with a nail driving assembly of a nail gun, comprising:
an axle coupled with the nail loading assembly, the axle for providing an axis of rotation and the nail loading assembly being an adjustable angle magazine; and
a pinion coupled with the axle by a first mounting member and a second mounting member pivotally coupled with the adjustable angle magazine, the pinion for engaging a nail advancing down the nail loading assembly,
wherein the pinion assembly allows the nail to advance to the nail driving assembly when the nail is correctly positioned parallel with the axis of rotation of the axle.

42. The pinion nail verification assembly of claim 41, further comprising a lock assembly coupled with the pinion, the lock assembly for locking the position of the pinion.

43-44. (canceled)

45. The pinion nail verification assembly of 41, wherein the adjustable angle magazine further comprises an articulating pusher assembly.

46. The pinion nail verification assembly of claim 41, wherein the adjustable angle magazine further comprises a nail shank pawl assembly.

47. The pinion nail verification assembly of claim 41, wherein the nail gun is selected from the group consisting of a spring-loaded nail gun, a pneumatic nail gun, an electromagnetic nail gun, a combustion nail gun, and a motor driven nail gun.

48. The pinion nail verification assembly of claim 41, wherein the nail gun further comprises a clutch assembly.
